(19) United States
(12) Patent Application Publication
(10) Pub. No.: US 2018/0168388 A1
(43) Pub. Date: Jun. 21, 2018

(54) COLD BREW COFFEE MAKER WITH WATER DRIP SUPPLY UNIT AND COFFEE EXTRACTION GUIDE MEMBER

(71) Applicant: Seo-Ryoung Kim, Seogwipo-si (KR)

(72) Inventor: Seo-Ryoung Kim, Seogwipo-si (KR)

(21) Appl. No.: 15/451,726

(22) Filed: Mar. 7, 2017

(30) Foreign Application Priority Data
Dec. 21, 2016 (KR) 10-2016-0175392
Dec. 21, 2016 (KR) 10-2016-0175393

(51) Int. Cl. A47J 31/44; A47J 31/46

(52) U.S. Cl. CPC A47J 31/4403; A47J 31/44; A47J 31/46

(57) ABSTRACT

A cold brew coffee maker includes a water drip supply unit for dripping drops of water through a water dispensing port; a coffee container configured to steep the ground coffee in the coffee container to produce coffee extract using the water dripped from the water drip supply unit; a collecting container disposed below the coffee container and configured to collect the drops of the coffee extract dripping through a coffee extract dispensing port; and a collection guide member configured to guide the drops of the coffee extract to flow downward along the inner wall surface of the collecting container to fill the coffee extract collecting container. The water drip supply unit further includes a control unit configured to control an electric valve based on the water drop detection signal from a sensor unit so that the water drops can drip from the water dispensing port at a preset supply rate.

### REFERENCE TO RELATED APPLICATIONS

This application is based on and claims the priority benefit of Korean Patent Application No. 10-2016-0175392 filed on Dec. 21, 2016 and Korean Patent Application No. 10-2016-0175393 filed on Dec. 21, 2016, the entire contents of which are incorporated herein by reference.

### FIELD OF THE INVENTION

The present invention relates to a cold brew coffee maker with a water drip supply unit and a coffee extraction guide member, and more particularly, to a cold brew coffee maker which includes a water drip supply unit for extracting cold brew coffee which may automatically supply an appropriate amount of water, and a coffee extraction guide member for guiding drops of coffee extract from a coffee container in a manner such that the drops of the coffee extract are guided to flow downward along an inner wall surface of a collecting container or to rise from a bottom surface of the collecting container.

### BACKGROUND OF THE INVENTION

Recently, coffee lovers often drink coffee extracted by a water drip method in which liquid coffee is extracted from ground coffee using cold water over a long period of time.

Drip coffee generally refers to coffee made by putting ground coffee into a filter and then pouring hot water into the filter, but cold brew coffee refers to coffee extracted by dripping water drops at room temperature or a lower temperature onto ground coffee in a coffee container by a water drip method for a prolonged period of time, typically, five to twelve hours.

Since cold water or water at room temperature is used, the cold brew coffee is generally recognized as having aroma and a taste (flavor) differentiated from those of the coffee extracted by using hot water. To the contrary, hot water extraction of coffee can be problematic, often extracting a bad smell and volatilizing the good flavor. When hot water passes through the ground coffee, substances with poor flavor are also extracted and some substances of good flavor may easily volatilize if not coupled well to water molecules.

In contrast, according to the cold brew coffee extracting method, substances having good flavor are slowly extracted over a long period of time because the coffee is extracted by using cold dripped water. In addition, the flavor is preserved well in the liquid coffee because the coffee is extracted in a state in which the volatilization of a flavor is inhibited by using cold water. This method provides differentiated flavor characteristics of the coffee extracted by the cold water drip method.

As illustrated in FIG. 1, a typical cold brew coffee maker for extracting the coffee is configured such that a water tank 1, a coffee container 2, and an extracted coffee collecting container 3 are installed in a support structure or frame 4 so as to be sequentially disposed from top to bottom, such that water drops drip onto ground coffee c accommodated in the coffee container 2 through a water dispensing port 1a of the water tank 1, and coffee extract, which is extracted after passing through a filter f, is collected by dripping into the collecting container 3 through a coffee extract dispensing port 2a.

According to the cold brew coffee maker in the conventional art, a user minutely adjusts a valve v by hand, which is installed in the water dispensing port 1a of the water tank 1 in order to drip water drop by drop from the water tank 1 to the coffee container 2 at a predetermined time interval (or cycle). However, if a level of water stored in the water tank 1 is decreased, water pressure in the water tank is also decreased, such that the speed of the water drops flowing downward through a narrow gap in the water dispensing port 1a of the water tank 1 is gradually decreased, and as a result, the water drops stop dripping if the water tank is left unattended without being supplied with sufficient water. In particular, in the case of a small-sized coffee maker having a small water tank, the water drips slowly without stop in the valve, but in the case of a coffee maker having a water tank of about 1 liter or more, the water drops stop dripping several times.

Therefore, the user needs to continuously observe whether the water drops drip from the water tank 1 at an appropriate time interval or whether no water drop drips, and the user needs to manually manipulate the valve when the water drops do not drip at an appropriate supply rate (or drop cycle), which causes great inconvenience and cumbersomeness to the user. When a user notices that the water has stopped dripping from the water tank, it can be difficult for the user to determine the time elapsed since the last drop. If the drip had paused for a long time, the amount of water used to steep the coffee is greatly decreased. The overall extraction time needs to be constant each time the coffee is extracted in order to obtain a uniform flavor, and as a result, an operator excessively opens the valve in order to compensate for the lost time. As a result, the amount of water used to steep the coffee is greatly increased. If the water drops stop dripping several times and thus the degree to which the coffee is steeped is changed several times, it is difficult to exhibit an excellent taste and aroma of the cold brew coffee. In other words, if the problem of having to appropriately control the supply rate and cycle of the water drops is not solved, it is impossible to obtain the unique flavor and uniformity of cold brew coffee. In the above-described conventional method, it is difficult to regulate the drip to an appropriate supply rate, keep the extraction time constant, and maintain a consistent degree of steep, which makes it impossible to extract coffee with uniform quality in respect to aroma and taste.

Further, according to the aforementioned conventional cold brew coffee maker, drops of coffee extract produced in the coffee container drip directly onto the coffee extract collected in the collecting container, and thus the drops of the coffee extract repeatedly apply impact on the surface of the coffee extract stored in the collecting container. And as a result, the aroma is excessively dispersed throughout the extraction period and the taste is inconsistent.

In addition, in the case of the cold brew coffee maker in the conventional art, a large coffee container needs to be used and a feed rate of water drops per unit time needs to be increased in order to extract a large amount of coffee. However, even though a supply rate of water to be supplied to the coffee container 2 is increased by opening the valve 1a of the water tank 1 in order to extract large amount of coffee, it is impossible to obtain the brew coffee with good quality. The reason is that because a large amount of water drops is concentrically supplied only to the center of the coffee container 2, water is not to be appropriately and sufficiently diffused toward the outer wall side of the coffee container, and as a result, it is difficult to obtain a large amount of brew coffee with good quality and a uniform taste and flavor.

In addition, in the case of the conventional cold brew coffee maker, it is impossible to freely increase the diameter of the coffee container in order to extract a large amount of coffee. The reason is that when the water drips onto the surface of the ground coffee accommodated in the coffee container are diffused horizontally, the ground coffee is not sufficiently steeped in water toward the inner wall surface of the coffee container if the size of the coffee container is too large, and as a result, it is impossible to obtain a large amount of coffee extract with good quality and a uniform taste and flavor even though the diameter of the coffee container is increased.

### SUMMARY OF THE INVENTION

The present invention has been made in an effort to provide a cold brew coffee maker having a water drip supply unit for extracting coffee which may maintain a consistent and superior taste and aroma of coffee by automatically supplying water drops at an appropriate frequency.

The cold brew coffee maker of the present invention adopts an advanced automatic control technology that enables detection of a dripping water drop by an electronic or photo-electronic method and automatically adjusting an opening degree of a valve based on the acquired data of the dripping water so that the water drops drip onto ground coffee at an appropriate or optimal supply rate. The cold brew coffee maker of the present invention also adopts an advanced food science technology based on scientific analyses and researches on characteristics of the materials of coffee, and optimization of the supply of water drops for the coffee soaking/steeping process and the coffee extracting process in consideration of the materials of coffee, in order to produce cold brew coffee of high quality and aroma.

The present invention has also been made in an effort to provide a coffee maker with a water drip supply unit which may automatically supply water drops at an appropriate/optimal supply rate, may obtain a large amount of coffee extract of high quality by distributing the supplied water drops to a plurality of dispensing ports and then providing the water drops to a coffee container, and enable the drops of the coffee extract dripping from the coffee container to be collected by flowing downward along an inner wall surface of a collecting container without dropping directly on top of liquid coffee in the collecting container.

The present invention has also been made in an effort to provide a coffee extraction guide member and a cold brew coffee maker with the coffee extraction guide member, which guides drops of coffee extract extracted in the coffee container so that the drops of the coffee extract flow downward along an inner wall surface of a collecting container or that the coffee extract rises from a bottom surface of the collecting container in order to prevent dispersion of aroma and an inconsistent taste caused by repeated impact applied to the collected coffee extract when the drops of the coffee extract extracted in the coffee container drop directly on top of the coffee extract collected in the collecting container as in the conventional brew method discussed above.

The present invention has also been made in an effort to provide a coffee maker with a guide member, which may obtain a large amount of coffee extract with good quality by supplying water drops to be supplied to a coffee container through multiple-dripping points.

To achieve the above objects, the present invention provides a cold brew coffee maker including: a water drip supply unit including a water dispensing port configured to drip drops of water at a room temperature or below; a coffee container having an inner space for accommodating ground coffee therein, the coffee container disposed below the water drip supply unit and including a coffee extract dispensing port, and configured such that the water dripped from the water drip supply unit steeps the ground coffee in the coffee container to produce coffee extract, and that the produced coffee extract is dispensed in drops through the coffee extract dispensing port; a coffee extract collecting container disposed below the coffee container, and configured to collect the drops of the coffee extract dripping through the coffee extract dispensing port; and a guide member which is configured to guide the drops of the coffee extract to arrive at an inner wall surface of the collecting container such that the drops of the coffee extract dripping through the coffee extract dispensing port flow downward along the inner wall surface of the collecting container to fill the coffee extract collecting container, or which is configured to guide the drops of the coffee extract to a bottom surface of the collecting container such that the coffee extract rises from the bottom surface of the collecting container. The water drip supply unit is preferably configured to include: a sensor unit configured to detect the water drops dripping from the water dispensing port, and output a water drop detection signal; an electric valve for adjusting an opening degree of the water dispensing port; and a control unit configured to receive the water drop detection signal from the sensor unit, and control the electric valve based on the water drop detection signal so that the water drops drip from the water dispensing port at a preset supply rate.

The water supply source is preferably provided with a water tank having an inner space for storing water, and the water dispensing port is provided at a lower side of the water tank.

The control unit may be configured to detect a number of water drops from the water dispensing port per unit time (e.g., minute) using the water drop detection signal of the sensor unit, and control the electric valve so that the detected number of water drops per unit time is maintained to be equal to a preset number of water drops per unit time.

The control unit may be configured to detect a time interval of water drops from the water dispensing port using the water drop detection signal of the sensor unit, and control the electric valve so that the detected time interval of water drops is maintained to be equal to a preset time interval of water drops.

The sensor unit may be configured as an optical sensor including a light receiving part and a light emitting part which are installed at a lower side of the water dispensing port to detect the water drops dripping from the water dispensing port. The sensor unit may be configured as one of an infrared sensor, a laser sensor, an LED sensor, and a sensor with an electric circuit type contact switch, that are configured to detect the water drops dripping from the water dispensing port.

To achieve the above objects, the coffee extraction guide member may be configured to have an elongate tube shape with an inclined surface of a predetermined angle formed at a lower end of the elongate tube to facilitate the coffee extract to flow down along the inner wall surface of the coffee extract collecting container or to reach and rise from the bottom of the collecting container, without dropping to the bottom surface of the collecting container.

In another embodiment, the guide member may include an eccentric cone, the eccentric cone having a guiding outlet formed at a lower end of the eccentric cone in proximity or in contact with the inner wall surface of the collecting container, and configured such that the drops of the coffee extract dispensing from the coffee extract dispensing port are guided by the eccentric cone and flow down along the inner wall surface of the collecting container through the guiding outlet.

To achieve the above objects, a cold brew coffee maker of the present invention includes: a water drip supply unit configured to drip water drop by drop through a water dispensing port; a coffee container having an inner space for accommodating ground coffee therein, the coffee container disposed below the water drip supply unit and including a coffee extract dispensing port, and configured such that the water dripped from the water drip supply unit steeps the ground coffee in the coffee container to produce coffee extract, and that the produced coffee extract is dispensed in drops through the coffee extract dispensing port; a coffee extract collecting container disposed below the coffee container, and configured to collect the drops of the coffee extract dripping through the coffee extract dispensing port; and a guide member which is configured to guide the drops of the coffee extract to arrive at an inner wall surface of the collecting container such that the drops of the coffee extract dripping through the coffee extract dispensing port flow downward along the inner wall surface of the collecting container to fill the coffee extract collecting container, or which is configured to guide the drops of the coffee extract to a bottom surface of the collecting container such that the coffee extract rises from the bottom surface of the collecting container.

The cold brew coffee maker may further include a water drop distributing unit which is installed between the water drip supply unit and the coffee container and configured to receive water from the water drip supply unit and drip the supplied water in drops to the coffee container through a plurality of dispensing points.

As described above, the water drip supply unit for extracting coffee of the present invention may automatically supply an appropriate amount of water drops to the coffee container in accordance with a pre-programmed dripping cycle (or supply rate), and as a result, it is possible to obtain the good quality brew coffee with uniform taste and aroma of the coffee extract.

Further, it is not necessary for the user to manually adjust a valve, and the valve is precisely adjusted using a sensor unit to detect dripping of water drops and a controller to automatically adjust the valve opening size based upon the sensed data of the sensor unit. As a result, it is possible to reduce a cumbersome and a labor-consuming task of manually adjusting the valve in the conventional art, and a process of extracting coffee may be hygienically carried out because it is not necessary for the user to touch and directly adjust the valve.

The extraction guide member of the present invention guides the drops of the coffee extract discharged from the coffee container so that the drops of the coffee extract flow downward along the inner wall surface of the collecting container or that the coffee extract rises from the bottom surface of the collecting container, and as a result, it is possible to obtain brewed coffee with good quality and a good taste and aroma.

That is, when using a conventional coffee maker, the coffee extract repeatedly drips onto the reservoir of coffee extract in the collecting container over a long period of time. For example, to brew 1 liter of coffee, the coffee maker drips 9000 individual coffee drops, meaning impact is applied onto the collected coffee 9000 times. When impact is repeatedly and directly applied numerous times, the coffee aroma is excessively dispersed, the taste deteriorates, and a low quality coffee is brewed. The present invention incorporates a guide member that prevents the coffee extract from dropping directly onto the collected coffee extract. The coffee is collected without the repetitive impact, allowing the user to obtain coffee of high quality with more of the aroma and taste intact.

Further, the coffee maker with the guide member of the present invention includes a water drop distributing unit, and as a result, it is possible to obtain a large amount of coffee extract with good quality taste and aroma by distributing water supplied from the water drip supply unit to multiple points and dripping a plurality of water drops along a circumference at the outer periphery from the center of the coffee container.

### BRIEF DESCRIPTION OF THE DRAWINGS

FIG. 1 is a view illustrating a conventional cold-brew coffee maker;

FIG. 2 is a view illustrating a part of a brew coffee maker in which a water drip supply unit for extracting cold brew coffee according to an exemplary embodiment of the present invention is installed;

FIG. 3 is a partial cross-sectional view illustrating a state in which an electric valve in FIG. 2 is opened, partially opened, and closed;

FIGS. 4A, 4B, and 5 are views illustrating examples of the control device of the water drip supply unit, according to the present invention;

FIG. 6 is a view illustrating a part of the coffee maker of the present invention, in which the control device of the water drip supply unit according to FIG. 5 is installed;

FIG. 7A is a view illustrating the brew coffee maker to which a coffee extraction guide member according to the exemplary embodiment of the present invention is applied;

FIGS. 7B and 8 are views illustrating other shapes of the guide member in FIG. 7A;

FIG. 9 is an enlarged perspective view of the guide member in FIG. 8;

FIGS. 10 and 11 are views illustrating yet other shapes of the guide member of the present invention;

FIGS. 12, 13A, and 13B are views illustrating a coffee extraction guide member according to still another exemplary embodiment of the present invention;

FIG. 14 is a view illustrating the coffee maker to which the guide member of FIG. 13B is applied;

FIGS. 15A and 15B are views illustrating a coffee maker according to yet another exemplary embodiment of the present invention; and

FIGS. 16A and 16B are an exploded perspective view and an assembled view, respectively, which illustrate a state in which a water drop distributing unit and the coffee extraction guide member of FIG. 15B are coupled to a coffee container and an extracted coffee collecting container.

### DETAILED DESCRIPTION OF THE INVENTION

Various objects, features, and advantages of the present invention will be easily understood from the following exemplary embodiments associated with the accompanying drawings. However, the present invention is not limited to the exemplary embodiments disclosed herein, but may be embodied in different forms, and the exemplary embodiments disclosed herein are provided to merely transfer the main spirit of the present invention to those skilled in the art.

The same reference numbers are used throughout the drawings to refer to the same or like parts. The views in the drawings are schematic views only, and are not intended to be to scale or correctly proportioned. For the purposes of clarity and simplicity, detailed descriptions of well-known functions and structures incorporated herein may be omitted to avoid obscuring the subject matter of the present invention.

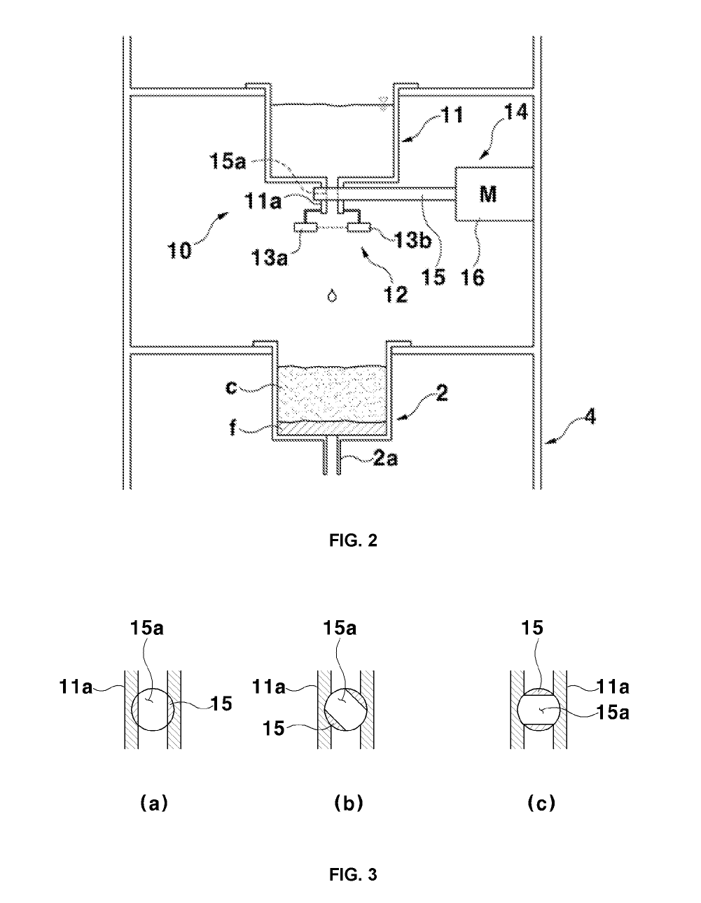

Hereinafter, a water drip supply unit 10 for extracting cold brew coffee according to an exemplary embodiment of the present invention is described with reference to FIGS. 2 to 4. The water drip supply unit 10 of the present invention may be configured to be installed at an upper side of a coffee container 2 of a coffee maker so as to be spaced apart from the coffee container 2 at a predetermined interval.

The water drip supply unit 10 of the present invention may include water tank 11 installed in the coffee maker, or be coupled to a water supply source (not illustrated) connected thereto, and further includes a sensor unit 12, an electric valve 14, and a control unit 18.

The water tank 11 is configured to a container shape, and has an internal space in which water may be stored, and a water dispensing port 11a which is provided at a lower side of the water tank 11 and discharges the water stored in the water tank 11. The electric valve 14 is installed in the water dispensing port 11a, and the electric valve 14 adjusts an opening degree of the water dispensing port 11a to enable the water to suitably drip drop by drop through the water dispensing port 11a.

In the present invention, the water tank (or water storage container) plays a predetermined role, but is not necessarily an essential constituent element. Therefore, it is noted that it is possible to configure the coffee maker of the present invention with a structure in which an appropriate amount of water is automatically supplied from a water supply source (not illustrated) without having the water tank, and the water is dispensed through the water dispensing port as described.

The sensor unit 12 is configured to detect water drops dripping from the water dispensing port 11a and outputs a water drop detection signal.

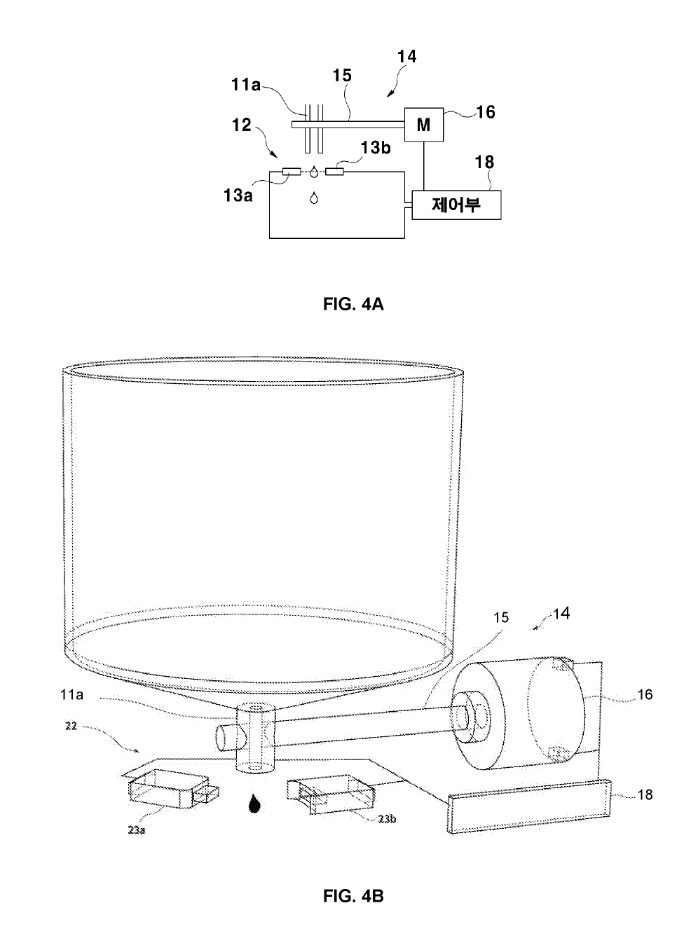

For example, as illustrated in FIGS. 2 and 4A, the sensor unit 12 is configured as an optical sensor including a light emitting part 13a and a light receiving part 13b. The light emitting part 13a and the light receiving part 13b are installed at a lower side of the water dispensing port 11a so as to be spaced apart from each other at a predetermined interval, and configured to be positioned at left and right sides on the route along which the water drops drip. That is, the sensor unit 12 of the present invention is configured to output the water drop detection signal to the control unit 18 when light (light wave) emitted by the light emitting part is not transmitted to the light receiving part because of the dripping water drops.

However, the present invention is not limited to the above configuration, and as illustrated in FIG. 4B, the sensor unit 22 of the present invention may be configured to output the water drop detection signal to the control unit 18 when light emitted by the light emitting part 23a is scattered by the water drops and the light receiving part 23b receives the scattered light. In this case, the light emitting part and the light receiving part are installed to be positioned at the left and right sides on the route along which the water drops drip, and in this case, the light emitting part 23a and the light receiving part 23b can be disposed at the same height so that light emitted by the light emitting part 23a may be scattered and refracted by the water drops and then received by the light receiving part 23b. However, the light emitting part 23a and the light receiving part 23b may be configured to be disposed at angles or axes different to a certain level, or positioned at different heights instead of being disposed at the same height.

According to one preferable embodiment, the electric valve 14 is configured to include a valve member 15 and a driving member 16. The valve member 15 may be formed in the form of a circular shaft having a passage opening 15a in a distal portion of the shaft as shown in FIG. 3, and is installed in the water dispensing port 11a in a state rotatable with respect to the water dispensing port 11a. According to the rotation angle of the shaft, the valve member 15 can be adjusted to a completely open state in which the passage opening 15a is completely coincident with the inner flow path of the water dispensing port 11a as illustrated in FIG. 3A, a partially opened state in which only a part of the inner flow path of the water dispensing port 11a is opened as the passage opening 15a is not aligned with the water dispensing port 11a as illustrated in FIG. 3B, and a completely blocked or close state in which the inner flow path of the water dispensing port 11a is completely blocked because the passage opening 15a and the water dispensing port 11a are disposed to be orthogonal to each other as illustrated in FIG. 3C.

Further, the valve member 15 can be rotated to assume various rotation angles by controlling the rotation of its actuator or motor 16, and thus an opening degree of the inner flow path of the water dispensing port 11a can be minutely adjusted. As the opening degree of the water dispensing port 11a is adjusted based on the rotation angle of the valve member 15 as described above, the time interval of the water drops dripping through the water dispensing port 11a can effectively be adjusted. The valve member 15 may be configured to have the same or similar shape as a conventional water tank valve of a cold brew coffee maker.

The actuator or motor 16 is configured as a servo motor to rotate the valve member 15, and controlled by the control unit 18. Here, the actuator 16 is described as being a servo motor, but it may be configured as various other actuators, such as a step motor other than the servo motor.

The control unit 18 can be connected with the sensor unit 12 and the driving motor 16 in a wired or wireless manner, receives the water drop detection signal from the sensor unit 12, and controls the actuator 16 based on the water drop detection signal, thereby enabling the dripping interval of the water dispensing port 11a to be maintained consistently at an appropriate water supply rate. Such water supply rates can be selected by user's selection of programmed set values from a menu of the coffer maker, or the user can directly input suitable supply rate data based on the characteristics of the coffee materials in use or other factors of cold brew process. As the optimal water supply rate is varied depending on the particular brewing steps, namely, the steeping step and the extracting step, it would be preferable that the water supply rate is set to different values optimized to the steeping step and the extracting step. For this, computer programs and data for achieving the above configuration are stored in the control unit of the device.

Specifically, the control unit 18 calculates a dripping time interval at which the water drops drip utilizing the water drop detection signal received from the sensor unit 12, and controls the electric valve 14 so that the detected dripping time interval is equal to a preset dripping time interval which is selected or inputted by the user or programmed for each steps of the coffee brewing step (i.e., the steeping step and the extracting step), and thereby maintaining an appropriate water dripping time interval.

For example, when a preset dripping time interval preset in the control unit 18 is 1.0 second and an actually detected dripping time interval calculated using the water drop detection signal from the sensor unit 12 is 1.2 second, the control unit 18 controls the electric valve 14 to increase the opening degree of the water dispensing port 11a, so that the time interval of the water drops dripping through the water dispensing port 11a becomes 1.0 second.

The control unit 18 counts and detects the number of water drops that drip from the water dispensing port for a predetermined period of time utilizing the water drop detection signal from the sensor unit 12, and controls the electric valve 14 so that the detected number of water drops per unit time (e.g., minute) is to be equal to the preset number of dripping water drops per unit time, and thus, enables to maintain the water dripping interval or the dripping frequency at constant or desired level.

That is, when the preset number of water drops per set time (which is preset in the control unit 18) is, for example, 60 drops per minute, and the number of current dripping water drops (which is calculated using the water drop detection signal from the sensor unit 12) is 50 drops per minute, the control unit 18 controls and adjusts the electric valve 14 to increase the opening degree of the water dispensing port 11a, and thus, enables the number of water drops through the water dispensing port 11a to become the preset value of 60 drops per minute.

In addition, the control unit of the present invention can be configured into various other types of operating units (not illustrated) in that the user is capable to preset desired operating values, for example, such as the dripping time interval, the number of water drops per unit time, and the like, in the control unit 18.

As explained above, it has been described that the control unit 18 of the present invention detects the dripping time interval or the dripping frequency (i.e., the number of dripping water drops per unit time), and controls and adjusts the electric valve 14 such that the dripping time interval or the number of dripping water drops per unit time is consistently maintained to be the preset value utilizing the detected dripping time interval or the detected number of dripping water drops per unit time. However, the present invention is not limited thereto, and may be implemented by adopting various other algorithms as long as the control unit 18 is configured to appropriately control the electric valve 14, based on the water drop detection signals received from the sensor unit 12, so as to maintain the dripping frequency or the supply rate of the water drops dripping from the water dispensing port 11a within a preset or intended range thereof.

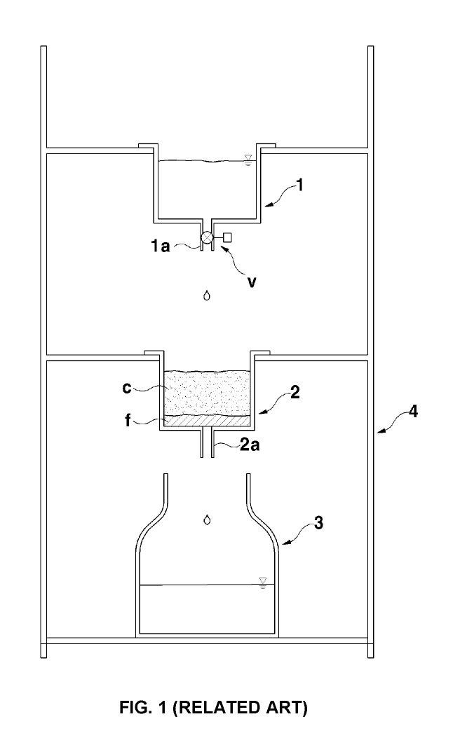

In the conventional art, as the opening degree of the water dispensing port 1a (see FIG. 1) is usually set to a constant value by operating the valve member 15, the dripping frequency (or supply rate) of the water drops from the water dispensing port 11a varies since the water pressure varies depending on the amount of remaining water in the water tank 1. However, in the present invention, the water drops from the water dispensing port 11a are detected by the sensor unit 11a, and the electric valve 14 is controlled based on the detected water drops, and as a result, it is possible to appropriately maintain the dripping frequency (or dispensing time interval) of the water drops dripping through the water dispensing port 11a, and thus, maintaining the supply speed or flow rate of the water drops even though the water level in the water tank 11 is decreased in use.

As described above, the present invention can maintain an appropriate supply rate of the water drops dripping through the water dispensing port 11a, and as a result, the water drops are supplied to the coffee container 2 at a predetermined rate, and thus, the taste and flavor of the coffee extract extracted from the coffee container becomes uniform.

Further, according to the present invention, it is not necessary for the user to manually manipulate the valve, and the valve is automatically operated, and as a result, it is possible to solve the existing problems caused when the user directly manipulates the valve, such as inconvenience of manual handling and contamination of valves, and thus, is capable of consistently maintaining a good hygienic condition.

In addition, the control unit 18 of the present invention can be configured to control the electric valve 14 based on the signal from the sensor unit 12 so as to maintain the supply rate of the water drops from the water dispensing port 11a to a first rate for a predetermined initial period of time, and then to a second rate higher than the first rate after the initial period of time and to the time when the extraction is completed.

That is, a process of extracting cold brew coffee may typically include a first steeping step in which water drops are supplied into the coffee container and the ground coffee is soaked and swells by the water, and a second steeping step in which the swelled ground coffee shrinks its volume and the coffee extraction progresses. Here, it is preferred to provide the water drops slowly in the first steeping step, and then at a slightly higher rate in the second steeping step than in the first soaking step. For this, the control unit 18 is configured to control the electric valve 14 to dispense at a first rate of, for example, forty (40) drops per minute in the first steeping step for the first three hours for instance, and increase to a second rate of, for example, sixty (60) drops per minute in the second steeping step after the initial three hours have passed.

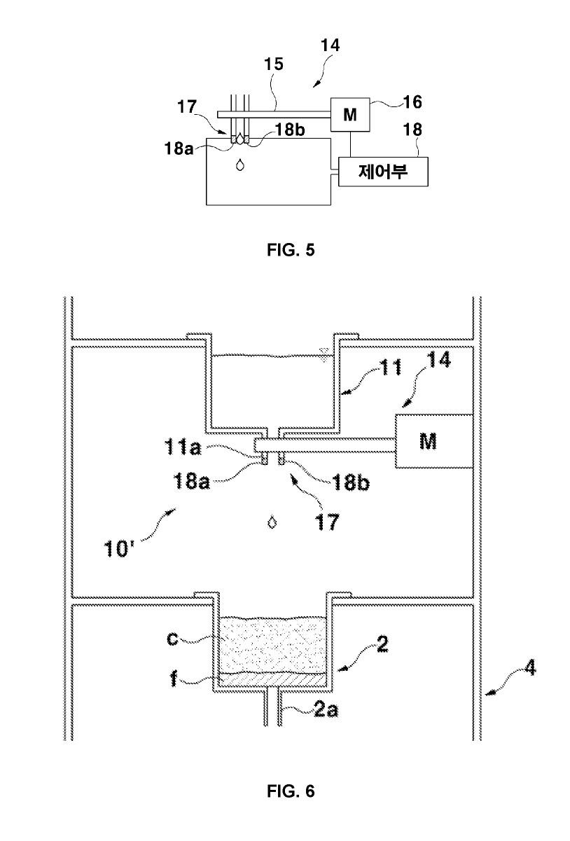

Hereinafter, a water drip supply unit 10′ for extracting cold brew coffee according to another exemplary embodiment of the present invention will be described with reference to FIGS. 5 and 6. The water drip supply unit 10′ just differs from the water drip supply unit in the aforementioned exemplary embodiment illustrated in FIGS. 2, 4A, and 4B in view of the configuration of the sensor unit 17, and the remaining configurations are identical to those in the aforementioned exemplary embodiment. Therefore, like reference numerals refer to like constituent elements and the description thereof will be omitted, and only the different configurations will be described.

In the water drip supply unit 10′ of the present exemplary embodiment, the sensor unit 17 can be configured as a contact switch of electric on-off circuit type which is configured to detect the water drops dripping from the water dispensing port 11a of the water tank 11.

The sensor unit 17 includes a plus (+) terminal part 18a and a minus (−) terminal part 18b which are installed at a lower end of the water dispensing port 11a so as to be spaced apart from each other and to face each other, and the + terminal part 18a and the − terminal part 18b are configured to be electrically connected with the control unit 18.

When a water drop having electric conductivity flows downwardly through the water dispensing port 11a, the water drop connects the + terminal part 18a and the − terminal part 18b so that the + terminal part 18a and the − terminal part 18b are electrically connected to each other (as shown in FIG. 5), and the control unit 18 detects the state in which the + terminal part and the − terminal part are connected to each other, thereby detecting the water drop.

According to the present invention, the water drops dripping through the water dispensing port 11a are detected by the sensor unit 17 in the form of an electric circuit type contact switch, and the control unit 18 receives the detection signal and controls the electric valve 14 in the same way as described above, and as a result, it is possible to maintain a constant supply rate of the water drops dripping through the water dispensing port 11a.

In the two types of exemplary embodiments according to the present invention, the sensor unit (12, 17) of the water drip supply unit (10, 10′) has been described as being configured as an optical sensor including the light emitting part and the light receiving part or an electrical on-off contact switch, but the present invention is not limited thereto, and the sensor unit may be configured as any type of sensor such as an infrared sensor, a proximity switch sensor, a laser sensor, an LED sensor, or an ultrasonic sensor as long as the sensor unit can detect the water drops dripping from the water dispensing port 11a.

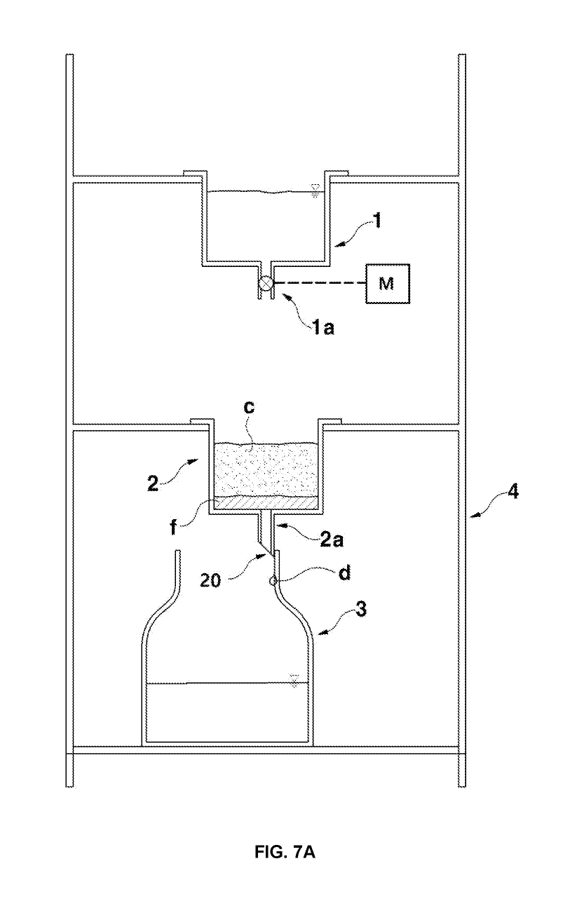

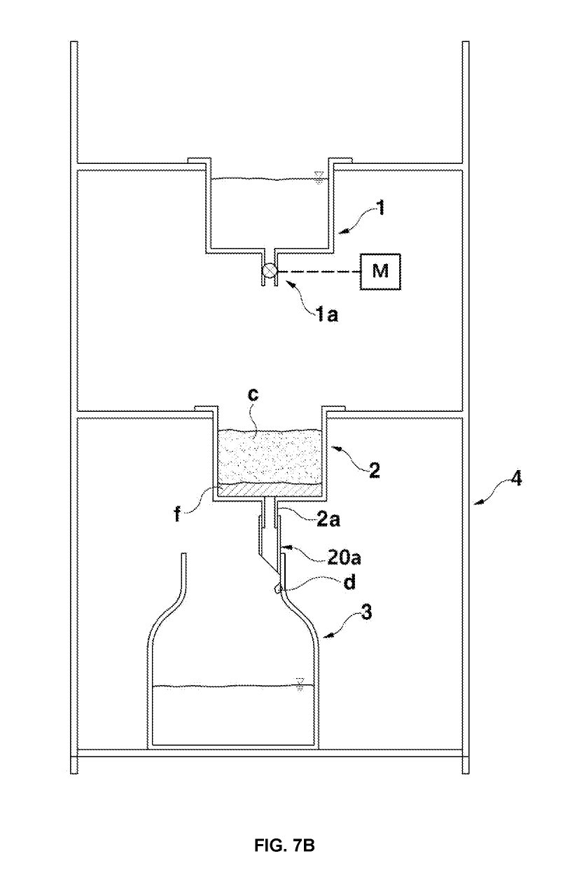

Hereinafter, a coffee extraction guide member or related configurations of the present invention and a process of extracting coffee using the same is described with reference to FIGS. 7A to 11.

The coffee extraction guide member of the present invention is configured as a guide member (or guiding configuration) 20 which allows the dripping coffee extract (which is extracted in the coffee container 2) to be guided so as to flow downward along the inner wall surface of the collecting container, or otherwise allows the coffee extract to rise from the bottom of the collecting container, so as to prevent the drops of the coffee extract from falling directly onto the collecting container 3 or the liquid coffee collected in the collecting container 3, and thus, preventing from repeated impact onto the collecting coffee in the collecting container.

Referring to FIG. 7A, the guide member 20 is in the form of a tube and formed integrally with the lower portion of the coffee extract dispensing port 2a of the coffee container 2, and a lower end of the guide member 20 is formed to have an inclined tip surface of a predetermined inclination angle.

The collecting container may be positioned and used such that a lowermost portion of the guide member 20, that is, a lower end of the inclined surface of the guide member 20 is in contact with the inner wall surface of the collecting container 3.

In this case, the coffee extract extracted in the coffee container 2 flows drop after drop through the coffee extract dispensing port 2a, and is guided to the inner wall surface of the collecting container through the guide member 20 such that the drops of the coffee extract flow downward along the inner wall surface of the collecting container, and are collected in the collecting container 3.

In a typical coffee maker, the lower end of a coffee extract dispensing port 2a is horizontally cut as illustrated in FIG. 1, and as a result, the drops of the coffee extract may fall or drop from various points at the circular lower end of the coffee extract dispensing port 2a, instead of falling from the same point. Therefore, in the conventional art, the drops of the coffee extract have a tendency to fall directly onto the liquid coffee collected in the collecting container 3 and apply impact to the liquid coffee collected in the collecting container 3, even though the coffee extract dispensing port 2a of the coffee container in FIG. 1 is positioned to be in contact with the inner wall surface of the collecting container 3 as illustrated in FIG. 7A. Thus, in the conventional art, the drops of the coffee extract dripping from the coffee extract dispensing port 2a fail to flow downward along the inner wall surface of the collecting container, and, as a result, the aroma of coffee is easily dispersed, and the taste of the brewed coffee is often not satisfactory.

However, according to the present invention, the coffee extract in the coffee container 2 flows downward along the guide member 20 through the coffee extract dispensing port 2a and is dispensed drop by drop while being guided to the inner wall surface of the collecting container 3 through the lower end of the inclined surface of the guide member 20 as described above, and the drops of the coffee extract flow downward along the inner wall surface of the collecting container and are collected in the collecting container 3. As a result, the aroma of coffee is not dispersed, and the good taste and quality of the brewed coffee can effectively be obtained.

As illustrated in FIG. 7A, the guide member 20 of the present invention is formed integrally with the lower end of the coffee extract dispensing port 2a of the coffee container, and the guide member 20 is preferably made of the same material as the coffee extract dispensing port 2a of the coffee container. If the coffee extract dispensing port 2a is made of a glass material, the guide member 20 is also made of a glass material, and if the coffee extract dispensing port 2a is made of a synthetic resin material, the guide member 20 may be made of the same kind of synthetic resin material. However, the present invention is not limited thereto, and the guide member 20 may of course be made of various other materials.

Meanwhile, the guide member 20 in FIG. 7A is described as being formed integrally with the lower end of the coffee extract dispensing port 2a, but as illustrated in FIG. 7B, the guide member 20a of the present invention can be separately formed and detachably fitted to the coffee extract dispensing port 2a. The guide member 20a may also have an appropriately curved tube shape instead of a straight tube shape as shown. In this case, the guide member 20a and the coffee extract dispensing port 2a can be made of the same material, and may of course be made of different materials.

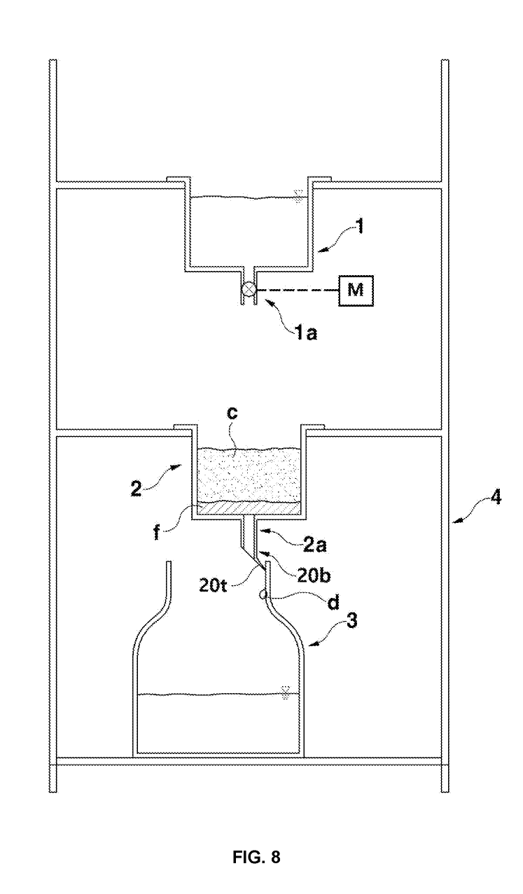

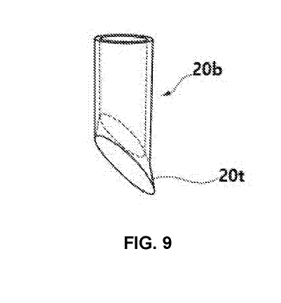

Referring to FIGS. 8 and 9, guide member 20b of the present invention can be configured such that a separate protruding portion 20t is provided integrally with the lower end of the inclined end surface thereof.

In this case, the protruding portion 20t is positioned to be in contact with the inner wall surface of the collecting container 3, such that the drops of the coffee extract can effectively be guided to reach the inner wall surface of the collecting container through the lower end of the inclined surface of the guide member 20b and the protruding portion 20t, so as to flow downward along the inner wall surface of the collecting container 3 for collection.

As described above, according to the present invention, the protruding portion 20t is additionally provided at the lower end of the inclined surface of the guide member 20b, and as a result, it is possible to more securely guide the drops of the coffee extract to flow through the inner wall surface of the collecting container.

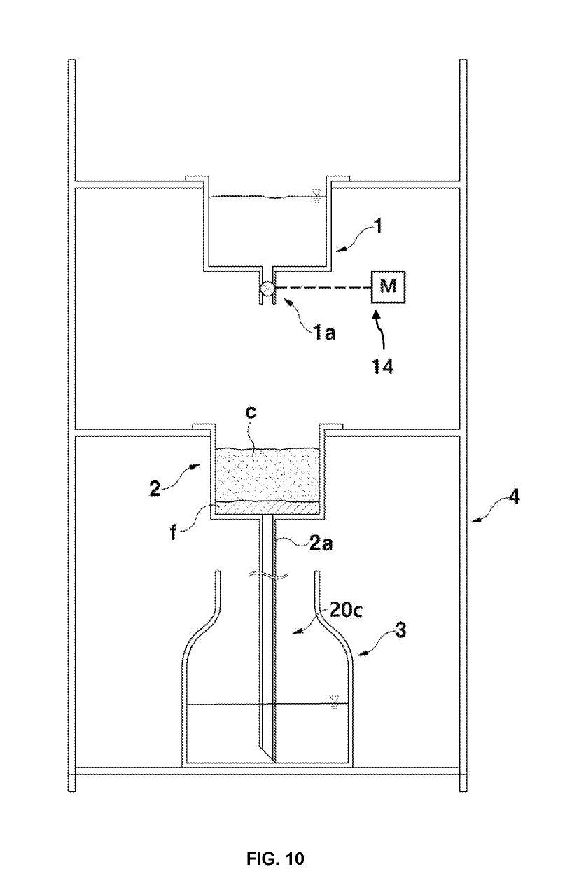

Referring to FIG. 10, guide member 20c of the present invention is formed to integrally extend from the coffee extract dispensing port 2a of the coffee container, and has an extended length such that the lowermost end of the inclined surface of the guide member 20c is in contact with or in close proximity to the bottom surface of the collecting container 3.

In this case, the coffee extract extracted in the coffee container 2 is dispensed to come into direct contact with the bottom surface of the collecting container through the coffee extract dispensing port 2a and the guide member 20c, such that the coffee extract rises from the bottom of the collecting container without impacting to the collecting coffee.

As described above, since the drops of the coffee extract are dispensed to come into contact with the bottom of the collecting container through the guide member 20c, the drops of the coffee extract do not apply impact to the surface of the collected coffee extract, thereby preventing the coffee aroma from being dispersed.

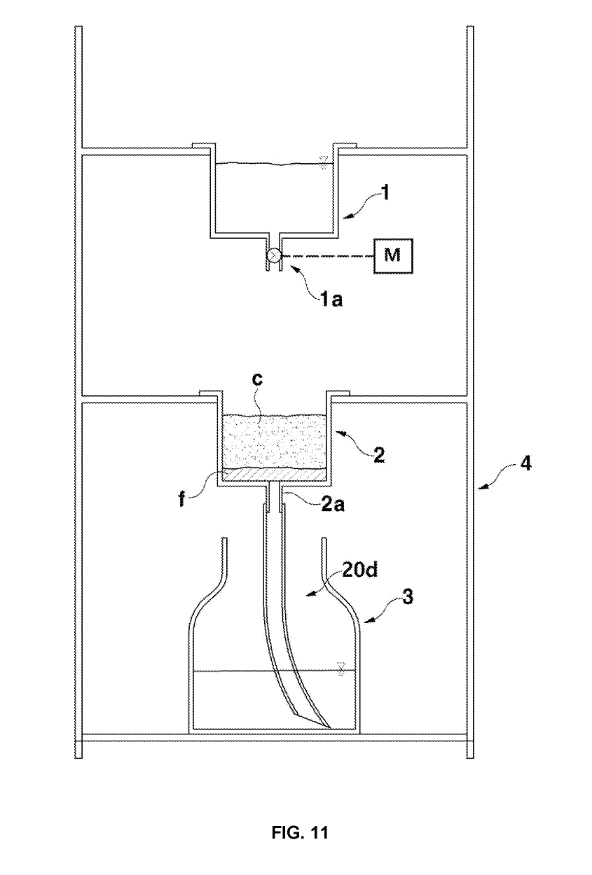

Referring to FIG. 11, guide member 20d of the present invention is configured separately from the coffee extract dispensing port 2a, and preferably made of a flexible material. In addition, the guide member 20d is configured to be fitted to the coffee extract dispensing port 2a, and has an extended length such that the lowermost end of the inclined surface of the guide member 20d may be in contact with the bottom surface of the collecting container in a state in which the guide member 20d is fitted with the coffee extract dispensing port 2a.

Even in this case, the coffee extract is dispensed to come into contact with the bottom of the collecting container through the guide member 20d, and as a result, the flowing coffee extract does not apply impact to the surface of the collected coffee extract, and thus, a quality coffee extract with good aroma and taste can be obtained.

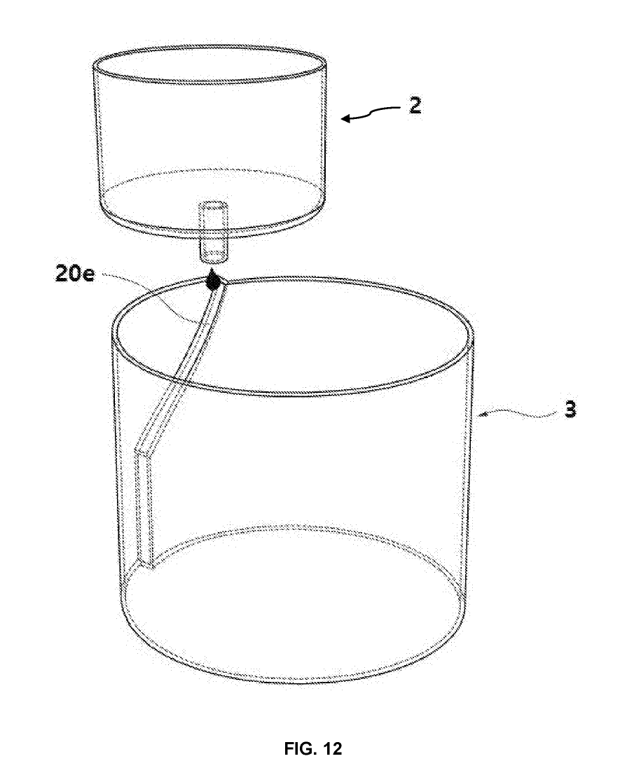

Hereinafter, coffee extraction guide member 20e according to still another exemplary embodiment of the present invention is described with reference to FIG. 12.

As described, the above guide members (20, 20a through 20d) are elements formed at and in association with the coffee extract dispensing port 2a of the coffee container, but the guide member of the present embodiment differs from the guide members (20, and 20a to 20d) in that it is configured as a guide member or features formed at or in association with the wall of the collecting container.

More specifically, the guide member 20e of this embodiment is formed at the inner wall of the collecting container 3, and includes a curved and band-shaped guide portion with a predetermined width and length, and extends in obliquely downward direction from an upper portion of the inner wall surface of the collecting container 3. The guide member 20e of the collecting container 3 is to be positioned such that the lower end of the coffee extract dispensing port 2a of the coffee container 2 is in close proximity to an upper side of the guide member 20e. With this configuration, drops of coffee extract dispensing through the coffee extract dispensing port 2a are suitably guided to the inner wall surface of the collecting container while flowing downward along the guide member 20e, and the drops of coffee extract flow downward along the inner wall surface of the collecting container and are effectively collected without causing repeated impact on the collecting coffee.

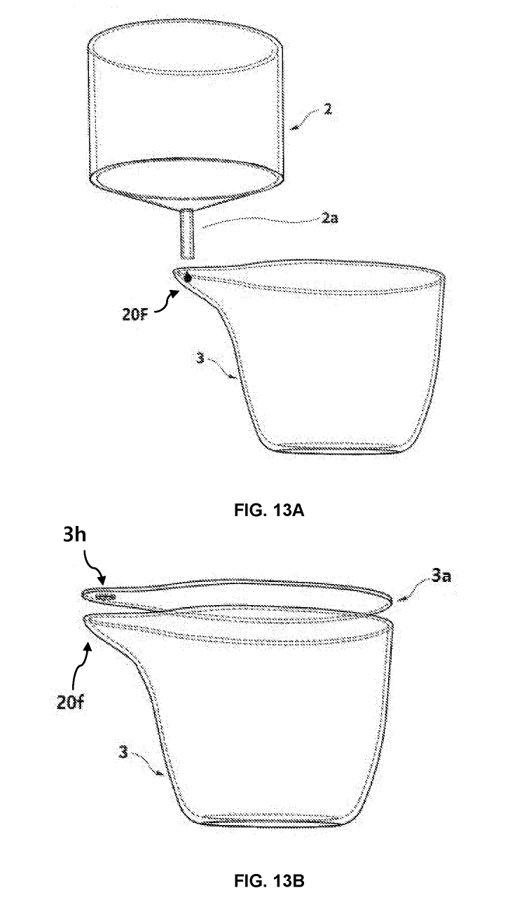

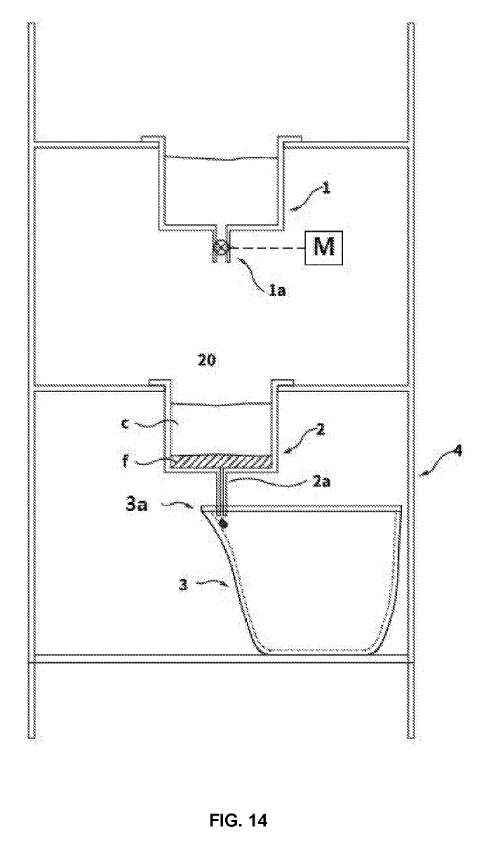

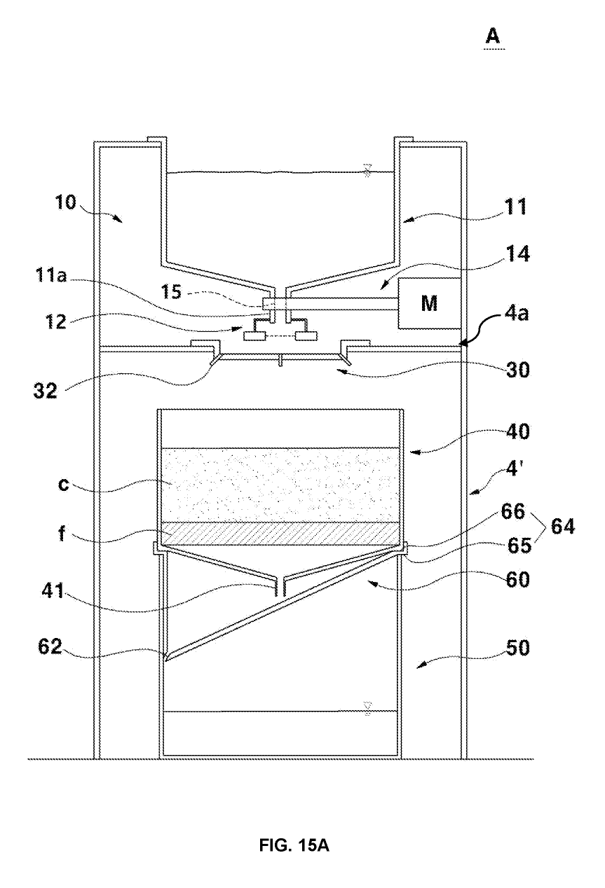

Hereinafter, a coffee extraction guide member 20f according to yet another exemplary embodiment of the present invention is described with reference to FIGS. 13A, 13B, and 14.

Similar to FIG. 12, the guide member in the present embodiment is guide member 20f formed obliquely downward and integrally coupled to the inner wall surface of the collecting container 3, and the guide member 20f is formed by reducing a wall portion of the collecting container 3 in a beaker or mouth shape. The collecting container 3 is to be positioned such that the lower end of the coffee extract dispensing port 2a of the coffee container is positioned in proximity at an upper side of the guide member 20f. In this case, the drops of coffee extract dispensing through the coffee extract dispensing port 2a flow downward along the curved guide portion of the guide member 20f, and are guided to the inner wall surface of the collecting container and collected in the container. The guide member 20f can also be used as a mouth or beaker to conveniently pour the collected liquid coffee into other containers or the like. Further, as illustrated in FIG. 13B, it is useful to have the collecting container 3 coupled with a lid 3a, which covers the upper end portion of the collecting container 3 and is installed at the upper side of the collecting container 3 to block an inflow of foreign substances such as dust. In addition, a through hole 3h of an appropriate size may be provided at a front end portion of the lid 3a, such that the through hole 3h is connected with the lower end portion of the coffee extract dispensing port 2a (see FIG. 14).

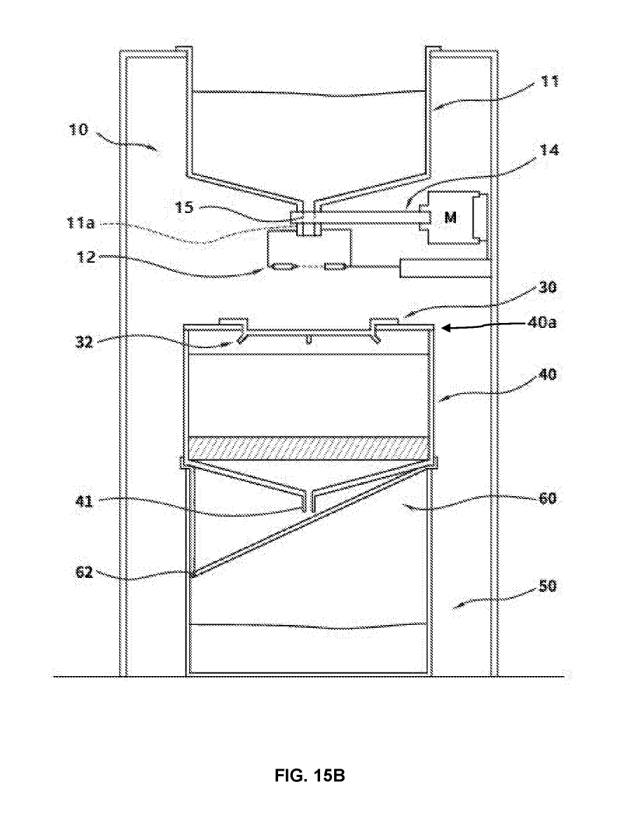

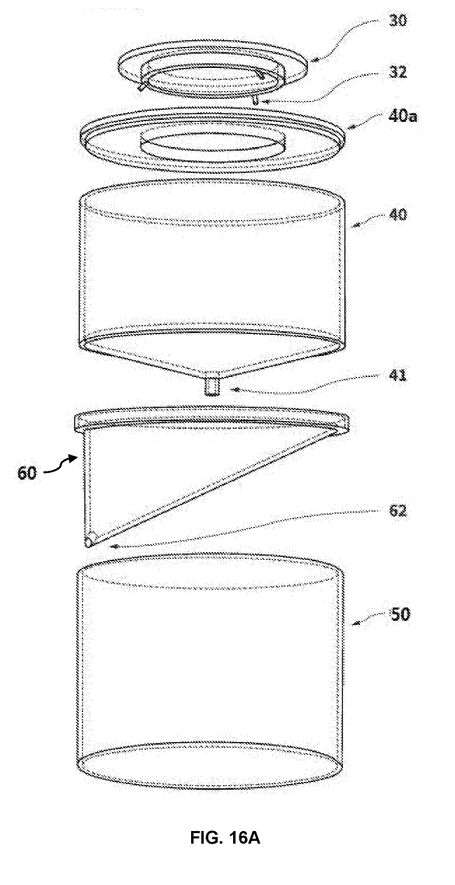

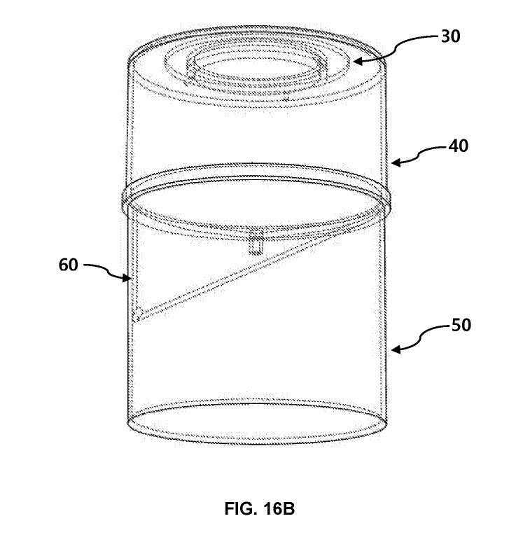

Hereinafter, a coffee extraction guide member 60 according to still yet another exemplary embodiment of the present invention and a brew coffee maker associated with the guide member is described with reference to FIGS. 15A to 16B.

The guide members of the aforementioned embodiments are configured to be formed on or in association with the coffee extract dispensing port 2a of the coffee container or the inner wall surface of the collecting container 3. However, the guide member 60 in the present exemplary embodiment is configured as an eccentric cone or funnel member, which is installed between the coffee container 40 and the collecting container 50, and configured to guide the drops of the coffee extract dispensing from the coffee extract dispensing port 41 to flow down into the collecting container 50.

The brew coffee maker “A” having the guide member 60 according to the present embodiment includes water drip supply unit 10, coffee container 40, collecting container 50, and the guide member 60 having an eccentric funnel shape. The water drip supply unit 10 includes the water tank 11 having water dispensing port 11a, sensor unit 12, electric valve 14, control unit 18, and other constituent elements. Because detailed structures and operating methods of main constituent members and components of these devices are identical to those in the aforementioned embodiments, descriptions thereof will be omitted, and the reference is to be made to the descriptions in FIGS. 2 to 6.

In the present embodiment, a water drop distributing unit 30 is additionally provided to more effectively provide the water drops to the ground coffee “c”. The water drop distributing unit 30 is formed in the form of a cup or other kinds of containers, and the water drop distributing unit 30 can be fixedly installed to a cross wall 4a that traverses the support structure 4′ as illustrated in FIG. 15A, or may be installed to a lid portion 40A that covers an upper end portion of the coffee container 40 as illustrated in FIG. 15B. The support structure 4′, the cross wall 4a, the lid portion 40A, and the like are constituent elements that support and connect the water drip supply unit 10 and the water drop distributing unit 30, and these constituent elements may of course have various other shapes.

The water drop distributing unit 30 is disposed at a lower side of the water tank 11 of the water drip supply unit 10 and configured to receive water drops from the water dispensing port 11a. The water drop distributing unit 30 is configured to have a plurality of (e.g., three) water dispensing ports 32 provided at an equal interval at a lower rim of the water drop distributing unit 30 as illustrated in FIGS. 15 and 16. In the present embodiment, a plurality of water drop distributing units 30 are configured to be disposed at an upper side of the coffee container 40, and disposed at equal or regular intervals along a circle concentric to the container 40.

With the aforementioned configuration, the water drops from the water dispensing port 11a are collected in the water drop distributing unit 30, and when the water level in the water drop distributing unit 30 becomes a predetermined level or higher, the water is distributed to the three water dispensing ports 32 and dripped to the coffee container 40 through the three water dispensing ports 32 due to water pressure or gravity.

As described above, the brew coffee maker “A” of the present invention is configured such that the water drips at an appropriate supply rate through the water drip supply unit 10, the water drops dripping through the water drip supply unit 10 are supplied to the water drop distributing unit 30, and the plurality of (e.g., three) drops of water are simultaneously supplied to the coffee container 40, and as a result, it is possible to obtain a large amount of coffee extract with good taste, aroma and quality.

In the conventional coffee maker configured to have the water dripped to a center of the coffee container through a single water dispensing port, the centrally dripped water in the ground coffee diffuses horizontally from the center of the coffee container 40 toward the wall surface of the coffee container, but the diffusion of water is not to be suitably carried out at the area close to the wall surface of the coffee container 40, and the ground coffee “c” is not sufficiently steeped in water, and as a result, it is impossible to obtain a large amount of coffee extract with good quality even though the supply rate of the dripping water, which drips drop by drop to the center of the coffee container, is greatly increased to cover the amount of ground coffee.

However, the coffee maker “A” of the present invention is configured such that the plurality of simultaneous drops of water, which is supplied from the water drip supply unit 10, drips to the coffee container through the water drop distributing unit 30, and the plurality of simultaneous drops of water drips to circumferential locations spaced apart from the center of the coffee container in an outer peripheral direction instead of dripping to the center of the coffee container 40. Therefore, the plurality of simultaneous water drops dripping to the coffee container 40 is effectively diffused throughout the ground coffee “c” in all directions toward the center of the coffee container and the inner wall surface of the coffee container. As a result, it is possible to obtain a large amount of coffee extract with good quality since the ground coffee is evenly steeped in the coffee container.

The water drop distributing unit 30 with three ports 32 is illustrated above, but the present invention is not limited thereto, and four or more water dispensing ports or two water dispensing ports may also be provided.

The coffee container 40 is installed below the water drop distributing unit 30, the filter “f” is provided at a lower side of the interior of the coffee container 40, and the interior of the coffee container 40 is filled with the ground coffee “c”. The coffee container 40 is supplied with the water drops which drip in such a way that three simultaneous drops of water drip through the water drop distributing unit 30, coffee extract is produced as the water drops pass through the ground coffee “c” and the filter “f”. A coffee extract dispensing port 41 is provided at a center of a lower side of the coffee container 40, such that the produced coffee extract drips drop by drop through the coffee extract dispensing port 41.

The collecting container 50 is installed below the coffee container 40, such that the coffee extract, which drips through the coffee extract dispensing port 41 of the coffee container, is collected in the collecting container.

The guide member 60 is installed between the collecting container 50 and the coffee container 40, and guides the drops of the coffee extract dripping from the coffee container so that the drops of the coffee extract flow along the inner wall surface of the collecting container 50. The guide member 60 is formed in an eccentric cone or funnel shape, and configured to be fitted into the collecting container 50 and to have a guide outlet 62 formed at an apex of the lower end of the funnel-shaped guide member 60. In addition, a mounting portion 64 having an “L”-shaped cross section is formed integrally with a rim of the upper end of the guide member 60. A first stepped portion 65, which is to be seated on the upper end of the collecting container 50, is formed at a lower side of the mounting portion 64, and a second stepped portion 66, on which the lower rim of the coffee container 40 is seated, is formed at an upper side of the mounting portion 64.

As illustrated in FIGS. 16A and 16B, according to the present invention, the constituent elements may be assembled such that the guide member 60 is inserted into the collecting container 50, and the coffee container 40 is placed on the upper portion of the guide member 60.

The first stepped portion 65 of the guide member 60 is seated on the upper tip of the collecting container 50 when the guide member 60 is inserted into the collecting container 50, and the lower rim portion of the coffee container 40 is seated on the second stepped portion 66 of the guide member 60 when the coffee container 40 is placed on the guide member 60. When the coffee container 40, the guide member 60, and the collecting container 50 are assembled as described above, the coffee extract dispensing port 41 of the coffee container 40 is in close proximity to the inner wall of the guide member 60 so as to be spaced apart from the guide member 60 at a fine interval, and a guide outlet 62 of the guide member 60 is in contact or close proximity with the inner wall surface of the collecting container 50. In this case, the interval between an end of the coffee extract dispensing port 41 and the guide member 60 may be smaller than 1 cm.

With the aforementioned configuration, the coffee extract produced in the coffee container 40 drips onto the inner surface of the guide member 60 through the coffee extract dispensing port 41, and is guided toward the inner wall surface of the collecting container 50 by the guide member 60, and the coffee extract is dispensed to the inner wall surface of the collecting container 50 through the guide outlet 62, and flows downward to the bottom side of the collecting container along the inner wall surface of the collecting container, and thus, the coffee extract is effectively collected.

As described above, since the guide member 60 is interposed between the coffee container 40 and the collecting container 50, the drops of the coffee extract dripping through the coffee extract dispensing port 41 of the coffee container 40 are guided toward the inner wall surface of the collecting container via the guide member 60 instead of falling directly onto the coffee extract collected in the collecting container 50, and as a result, the drops of the coffee extract flow downward along the inner wall surface of the collecting container, and then are accommodated in the collecting container.

In the conventional coffee maker, impact is repeatedly applied to the surface of the collecting coffee extract in the collecting container since the device is configured to have the drops of the coffee extract dripping through the coffee extract dispensing port 41 of the coffee container fallen directly onto the coffee extract in the collecting container 50, and as a result, the coffee aroma is excessively evaporated and the taste also becomes degraded when the brewing is completed. However, according to the present invention, the drops of the coffee extract dripping from the coffee container 40 are guided to the inner wall surface of the collecting container by the guide member 60, flow along the inner wall surface of the collecting container, and are collected in the collecting container. Therefore, no impact is applied to the collecting coffee extract in the collecting container, and as a result, it is possible to obtain quality coffee extract with good aroma and flavor.

Further, since the components of the present invention can be assembled by inserting and placing the guide member 60 into the collecting container 50, and placing the coffee container 40 on the guide member 60, it is possible to simplify the structure of the support structure 4′ because it is not necessary to provide a separate support member for supporting the guide member 60 and the collecting container 50. It is also possible to easily wash the coffee maker because these components may be easily disassembled and assembled, and the hygienic use of the coffee maker is guaranteed as foreign substances are prevented from entering within the collecting container 50 and other constituent components such as coffee container 40 and guide member 60.

As described above, the present invention has been illustrated and described with reference to the exemplary embodiments for exemplifying and explaining the principle of the present invention, but the present invention is not limited to the configurations and the operations as illustrated and described. It will be understood by those skilled in the art that various changes and modifications of the present invention may be made without departing from the spirit and the scope of the appended claims. Therefore, all of the appropriate changes, modifications, and equivalents thereto should be considered as being included in the scope of the present invention.

What is claimed is:

1. A cold brew coffee maker comprising:
a water drip supply unit including a water dispensing port configured to drip drops of water at a room temperature or below;
a coffee container having an inner space for accommodating ground coffee therein, the coffee container disposed below the water drip supply unit and including a coffee extract dispensing port, and configured such that the water dripped from the water drip supply unit steeps the ground coffee in the coffee container to produce coffee extract, and that the produced coffee extract is dispensed in drops through the coffee extract dispensing port;
a coffee extract collecting container disposed below the coffee container, and configured to collect the drops of the coffee extract dripping through the coffee extract dispensing port; and
a guide member which is configured to guide the drops of the coffee extract to arrive at an inner wall surface of the collecting container such that the drops of the coffee extract dripping through the coffee extract dispensing port flow downward along the inner wall surface of the collecting container to fill the coffee extract collecting container, or which is configured to guide the drops of the coffee extract to a bottom surface of the collecting container such that the coffee extract rises from the bottom surface of the collecting container,
wherein the water drip supply unit further includes:
a sensor unit configured to detect the water drops dripping from the water dispensing port, and output a water drop detection signal;
an electric valve for adjusting an opening degree of the water dispensing port; and
a control unit configured to receive the water drop detection signal from the sensor unit, and control the electric valve based on the water drop detection signal so that the water drops drip from the water dispensing port at a preset supply rate.

2. The cold brew coffee maker according to claim 1, wherein the water drip supply unit is provided with a water tank, the water tank having an inner space for storing water, and wherein said water dispensing port is provided at a lower side of the water tank.

3. The cold brew coffee maker according to claim 1, wherein the control unit is configured to detect a number of water drops from the water dispensing port per unit time using the water drop detection signal of the sensor unit, and control the electric valve so that the detected number of water drops per unit time is maintained to be equal to a preset number of water drops per unit time.

4. The cold brew coffee maker according to claim 1, wherein the control unit is configured to detect a time interval of water drops from the water dispensing port using the water drop detection signal of the sensor unit, and control the electric valve so that the detected time interval of water drops is maintained to be equal to a preset time interval of water drops.

5. The cold brew coffee maker according to claim 1, wherein the sensor unit is an optical sensor including a light receiving part and a light emitting part which are installed at a lower side of the water dispensing port to detect the water drops dripping from the water dispensing port.

6. The cold brew coffee maker according to claim 1, wherein the sensor unit is one of an infrared sensor, a laser sensor, an LED sensor, and a sensor with an electric circuit type contact switch, configured to detect the water drops dripping from the water dispensing port.

7. The cold brew coffee maker according to claim 1, wherein the guide member is configured to have an elongate tube shape with an inclined surface of a predetermined angle formed at a lower end of the elongate tube to facilitate the coffee extract to flow down along the inner wall surface of the coffee extract collecting container without dropping to the bottom surface of the collecting container.

8. The cold brew coffee maker according to claim 1, wherein the guide member is configured to have an elongate tube shape with a predetermined length such that a lower end of the elongate tube is in proximity or in contact with the bottom of the collecting container to guide the drops of the coffee extract to the bottom surface of the collecting container to have the coffee extract rising from the bottom surface of the collecting container.

9. The cold brew coffee maker according to claim 1, wherein the guide member includes an eccentric cone, the eccentric cone having a guiding outlet formed at a lower end of the eccentric cone in proximity or in contact with the inner wall surface of the collecting container, and configured such that the drops of the coffee extract dispensing from the coffee extract dispensing port are guided by the eccentric cone and flow down along the inner wall surface of the collecting container through the guiding outlet.

10. A cold brew coffee maker comprising:
a water drip supply unit configured to drip water drop by drop through a water dispensing port;
a coffee container having an inner space for accommodating ground coffee therein, the coffee container disposed below the water drip supply unit and including a coffee extract dispensing port, and configured such that the water dripped from the water drip supply unit steeps the ground coffee in the coffee container to produce coffee extract, and that the produced coffee extract is dispensed in drops through the coffee extract dispensing port;
a coffee extract collecting container disposed below the coffee container, and configured to collect the drops of the coffee extract dripping through the coffee extract dispensing port; and
a guide member which is configured to guide the drops of the coffee extract to arrive at an inner wall surface of the collecting container such that the drops of the coffee extract dripping through the coffee extract dispensing port flow downward along the inner wall surface of the collecting container to fill the coffee extract collecting container, or which is configured to guide the drops of the coffee extract to a bottom surface of the collecting container such that the coffee extract rises from the bottom surface of the collecting container.

11. The cold brew coffee maker according to claim 10, further comprising a water drop distributing unit which is installed between the water drip supply unit and the coffee container and configured to receive water from the water drip supply unit and drip the supplied water in drops to the coffee container through a plurality of dispensing points.

12. The cold brew coffee maker according to claim 11, in which the water drop distributing unit has a shape of a cup or container, and a plurality of water dispensing ports is formed at a lower rim of the water drop distributing unit, the water dispensing ports are arranged at regular intervals.

13. The cold brew coffee maker according to claim 10, wherein the water drip supply unit further includes:
a sensor unit configured to detect the water drops dripping from the water dispensing port, and output a water drop detection signal;
an electric valve for adjusting an opening degree of the water dispensing port; and
a control unit configured to receive the water drop detection signal from the sensor unit, and control the electric valve based on the water drop detection signal so that the water drops drip from the water dispensing port at a preset supply rate.
